(19) United States
(12) Patent Application Publication
(10) Pub. No.: US 2012/0311461 A1
(43) Pub. Date: Dec. 6, 2012

(54) METAPHOR ELICITATION TOOL

(75) Inventors: Philip Granof, Newton, MA (US); Anders Bengtsson, Somerville, MA (US)

(73) Assignee: Protobrand Sciences, LLC, Boston, MA (US)

(21) Appl. No.: 13/154,105

(22) Filed: Jun. 6, 2011

(51) Int. Cl. G06F 3/01; G06F 15/16

(52) U.S. Cl. 715/753

(57) ABSTRACT

Participants in a metaphor elicitation study may be remotely queried to select images which they associate with a prescribed topic of inquiry, and then asked to textually input responses to one or more questions relating to the selected images and/or the topic of inquiry. The group of images from which each participant selects images may be predetermined by the study administrator.

### FIELD OF THE INVENTION

This invention relates generally to metaphor elicitation techniques, and more specifically to apparatuses and methods for implementing metaphor elicitation techniques.

### DISCUSSION OF THE RELATED ART

Metaphor elicitation techniques are an outgrowth of Conceptual Metaphor Theory, which was developed by researchers within the field of cognitive linguists, and became widely known with the publication of “Metaphors We Live By,” by Lakoff and Johnson, in 1980. Conceptual to Metaphor Theory has since been further developed and put into practical application in marketing research to discover the deep-seated thoughts and feelings of consumers.

Metaphor elicitation in particular is part of a larger set of research methods referred to as projective techniques. The Association of Qualitative Practitioners defines projective techniques as “ . . . a wide range of tasks and games in which respondents can be asked to participate during an interview or group [i.e., face-to-face settings], designed to facilitate, extend or enhance the nature of the discussion.” Further, “ . . . projective techniques facilitate the articulation of otherwise repressed or withheld ideas by the allowing the research participant or subject to ‘project’ their own thoughts onto an object other than themselves. Projective techniques are thus techniques that enable research participants or subjects to respond in ways in which they would otherwise not feel able to respond.” Boddy C. (2005) Projective Techniques in Market Research, 47, 1, p. 239.

In metaphor elicitation, research subjects are asked think about a topic in terms of another object. Typically this other object is a picture or a photograph. “Pictures typically represent not only basic lower-order concepts, but also higher-order constructs that contain extensive information or defining attributes. Due to the expressive power of pictures, it is not surprising that photographs have been a central part of counseling, sociology, psychology, and anthropology.” (Coulter, Zaltman, and Coulter. 2001 Journal of Advertising, Volume XXX, Number 4, Winter.) So, rather than respond to the topic with words, subjects are often asked to respond to the topic visually, presenting a picture to the researcher that represents their thoughts and feelings. The exercise of relating one object to another elicits metaphorical thinking in the subject and provides insights into hidden mental schema. While thoughts are ultimately expressed verbally, the thought-process may be nonverbal such that images are created in the process.

Metaphor elicitation typically has been performed with face-to-face interviews or conversations between an interviewer and a study participant. The conversations may be recorded for purposes of reviewing voice inflection and tone.

### SUMMARY

Metaphors are a critical part of thinking and a useful mechanism to study and understand consumer behavior, thoughts, and feelings. Emotions and rationale intermingle in the minds of consumers, and each person possesses a mental model, often below conscious awareness, which represents his or her truest conceptions and emotions regarding a given topic. By encouraging and eliciting metaphorical comparison, the foundational and hidden cognitive structures that people use to frame their reality can be discovered. Embodiments provided herein are directed to tools and methods which may improve the type and quality of elicited feedback, and also may increase the efficiency of eliciting feedback from participants as part of a metaphor elicitation study.

According to one embodiment, a server device is configured to elicit descriptions from participants regarding relationships of images to a topic of inquiry, the images being obtained from a computer storage medium storing a group of images. The server device comprises one or more processors configured by stored program instructions to send an indication of a topic of inquiry to a plurality of client devices which are remote from the server device, and to send a plurality of images from the group of images to each of the client devices. The one or more processors are also configured to send a first request to each of the client devices for display to an associated participant, the request requesting the participant to select a number of images, from among the plurality of images, which the participant associates with the topic of inquiry. Further, the one or more processors are configured to send a second request to each of the client devices for display to the associated participant, the request requesting the participant to explain how the participant associates the selected images to the topic of inquiry, and to receive the explanations of how the participants associate the selected images to the topic of inquiry. The processors are also configured to store on a computer storage medium identifications of the images selected by participants and the explanations associated with the selected images.

According to another embodiment, a computer-implemented method elicits written accounts from participants regarding relationships of selected images to a topic of inquiry. The method includes acts of sending an indication of a topic of inquiry to each of a plurality of participants, operating a computer-implemented system to send a plurality of images to each participant, and sending a request to each participant to select a number of images from among the plurality of images which the each participant associates with the topic of inquiry. The method also includes sending a request to each participant to provide a textual account regarding how the participant associates images selected by the participant with the topic of inquiry. One or more of these acts may be performed by operating a computer-implemented system.

According to another embodiment, at least one non-transitory computer-readable storage medium has instructions stored thereon which, when executed, cause one or more computer processors to perform a method for eliciting statements from each of a plurality of participants about how each participant associates selected images with the topic of inquiry. The method includes acts of sending an indication of a topic of inquiry to a first participant who is viewing a first display device and to a second participant who is viewing a second display device, and sending a first plurality of images to the first display device to be displayed in a first order, the first plurality of images being from a first group of images. The method further includes sending a second plurality of images to the second display device to be displayed in a second order different from the first order, the second plurality of images being from a second group of images. The first group and the second group of images are the same in some embodiments, while the first group and the second group of images are different in other embodiments. Further acts include sending a request to the first participant to select a number of images from among the first plurality of images which the first participant associates with the topic of inquiry, and sending a request to the second participant to select a number of images from among the second plurality of images which the second participant associates with the topic of inquiry. Additionally, the method includes sending a request to the first participant to explain how the first participant associates the first participant's selected images with the topic of inquiry, and sending a request to the second participant to explain how the second participant associates the second participant's selected images with the topic of inquiry.

The request for the selection of images which the first participant associates with the topic may be a request for the selection of images which the first participant regards as representing the thoughts and/or feeling of the first participant about the topic of inquiry. The request for an explanation by the first participant of how the first participant associates the selected images with the topic may be a request for an explanation as to how the selected images relate to the thoughts and/or feelings of the first participant. Similar requests may be sent to the second participant. The method may include requesting that each participant describe the selected images.

The requests may include a request for the participants to select a predetermined number of images. The first plurality of images is the same as the second plurality of images in some embodiments, and in other embodiments, the first plurality of images is different from the second plurality of images. The first order and/or the second order of the images may be selected using a randomizer. The method may include sending the requests to each participant at different times, and further may include receiving responses from each participant at different times.

### BRIEF DESCRIPTION OF DRAWINGS

Other advantages, features, and uses of the invention will become apparent from the following detailed description of non-limiting embodiments of the invention when considered in conjunction with the accompanying drawings, which are schematic and which are not intended to be drawn to scale. In the figures, each identical or nearly identical component that is illustrated in various figures typically is represented by a single numeral. For clarity, not every component is labeled in every figure, nor is every component of each embodiment of the invention shown where illustration is not necessary to allow those of ordinary skill in the art to understand the invention.

FIG. 1 is a diagram illustrating an example of a network environment in which metaphor-elicitation studies may implemented;

FIG. 2 is a flowchart illustrating one example of a method of performing a metaphor-elicitation study;

FIG. 3 is an example of images being presented to a study participant on a user interface;

FIG. 4 is an example of a request for response being presented to a study participant on a user interface; and

FIG. 5 is another example of a request for response being presented to a study participant on a user interface.

### DETAILED DESCRIPTION

According to embodiments disclosed herein, participants in a metaphor elicitation study may be remotely queried to select images which they associate with a prescribed topic of inquiry, and then asked to textually input responses to one or more questions relating to the selected images and/or the topic of inquiry. In some embodiments, the group of images from which each participant selects images may be predetermined by the study administrator.

We have recognized the benefits of performing metaphor elicitation with approaches that have not previously been used. For example, using the tools and methods described herein, metaphor elicitation techniques may be used to produce more robust results as compared to typical face-to-face interviews. Additionally, by requesting textual responses, as compared to verbal responses, the participant responses may be more concise and thus lend themselves to better and more efficient analysis. Further, the textual input can reduce data recordation errors as compared to live person interviews or conversation-based sessions. The textual responses can be used as part of a fully automated or a partly-automated analysis by inputting the data into textual analysis software. The use of remote inquiries also reduces or removes possible interviewer bias. Further, certain methods and tools disclosed herein for metaphor elicitation permit a participant to carry out their interaction at his or her time and place of choice, and reduces possible social and physical pressures of a face-to-face interview.

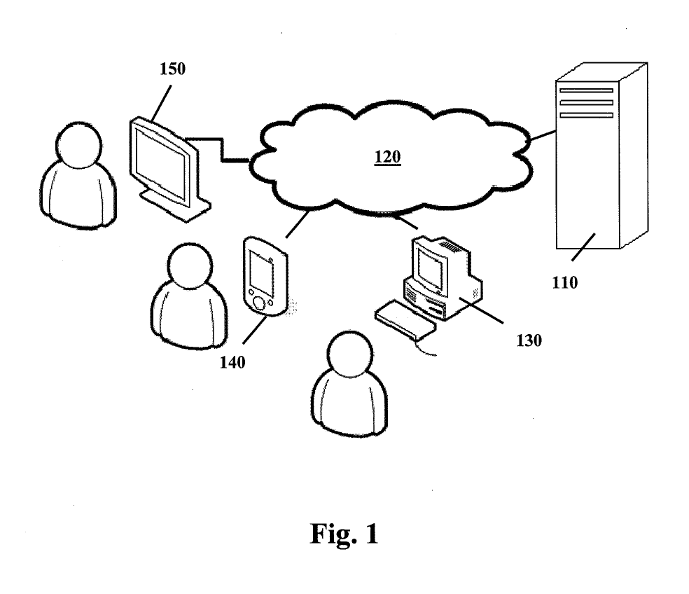

According to some embodiments, a server device sends a topic of inquiry, images, and various requests to remote client devices via a network. In return, the server device receives, via the network, indications of images selected by participants at the remote client devices, as well as the participants' responses to the requests. For example, as shown in FIG. 1, a server device 110 is connected via a network 120 such as the Internet, to a plurality of client devices. Each of the client devices may be any suitable device which allows a participant to receive and send information via the network, such as a computer 130, a mobile phone 140, or a display device 150 having a touch screen interface. Any other suitable devices, such as a tablet computer or a personal digital assistant, may be used as client devices. Server device 110 may be a central computer which is programmed to send requests to the client devices, and further programmed to receive responses from the client devices. In some embodiments, the server device may be distributed among, and implemented on, multiple platforms. For example, a first device may direct a second device at a different location from the first device to send images and requests to client devices. The first device then may receive responses from the client devices. The server device may obtain images to be sent to client devices from a computer storage medium that is part of the same physical device as the processor, or the server device may obtain the images from a computer storage medium that is located remotely from the server device. For purposes herein, the term “send”, when referring to sending images, requests, and/or other data, includes sending data from a first device, as well as instructing and/or causing a second, different device to send data.

Communications between the server device 110 and the client devices 130, 140 and 150 can take place simultaneously or at different times for each client device. In some embodiments, images and information requests can be sent to a client device in a single transmission, and a participant may use the client device at a later time to complete their portion of the study. In such an embodiment, the images and requests may be sent to a participant, and an entire set of responses may be received at a later time in a single transmission. In other embodiments, images and information requests may be sent to a participant, and the server device waits for a response from the participant before proceeding to a next step. In this manner, the server device may be used to monitor progress and responses to possibly adjust the communications based on the responses.

The use of a remote querying system as disclosed herein can produce high quality results in part because the process is driven by the participants in a non-hurried, anonymous setting.

The participants are able to take part at a time that is convenient for them, resulting in relaxed, thoughtful session without social and physical pressures. Rather than imposing predetermined questions, certain of the requests disclosed herein encourage the participants to determine what is important, rather than imposing predetermined questions which may steer participants in a direction not of their choosing. For example, no matter how carefully a set of questions is constructed, the questions may contain researcher assumptions. By simply requesting a participant's thoughts and feelings regarding how an image relates to the topic of inquiry, the answers are produced based on self-generated, non-verbal frames-of-reference that draw on the naturally occurring metaphorical processes important to human cognition. The use of participants' self-generated metaphorical frames-of-reference allows the participants to quickly reveal their thoughts.

Compared to traditional focus groups or one-on-one interviews in which the sought after data can be potentially buried within hours of transcript and extraneous discussion, the use of textual response and/or a particular question as to how the participant associates the image with the topic can produce concise data which is directly connected to the topic of inquiry.

Deployment of metaphor studies over a network can produce efficiencies which allow for greater numbers of participants, thereby producing results which may be more statistically relevant than results possible with one-on-one interviews. For example, in some embodiments, 50 or more participants can be accommodated, or 100 or more participants can be accommodated, and in some embodiments, 500 or more participants can be accommodated.

The textual data produced by methods disclosed herein lends itself well to computer-assisted qualitative and/or quantitative data analysis programs. Through the use of linked coding schemes, hypertext, and case-based hypothesis testing, non-obvious deep interconnections and insights may be extracted from participant responses. Further development of computer-assisted qualitative data analysis programs will allow for greater automation of the hunt for meaning.

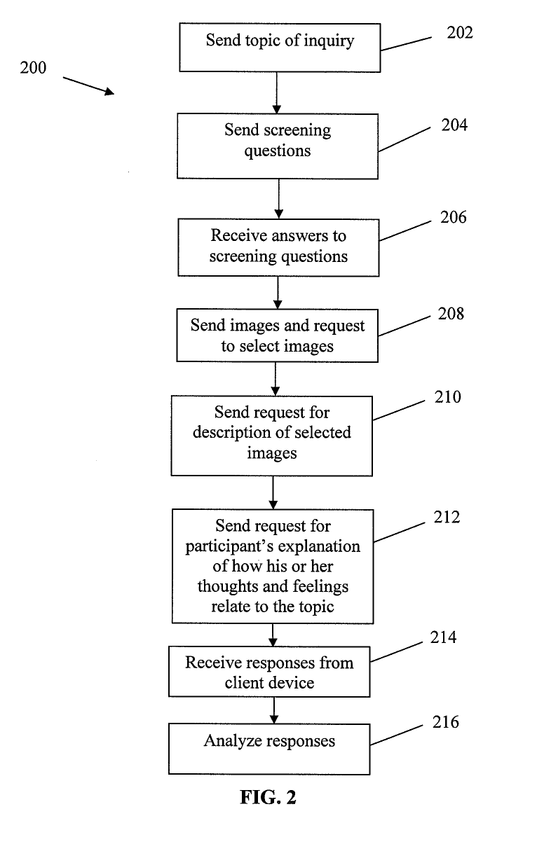

One embodiment of a method 200 of performing a metaphor elicitation study is described below with reference to FIG. 2. In an act 202, a topic of inquiry is sent to a client device for a participant to read, see or hear. For example, the name of a retail company, a brand of food products, or a candidate for political office may be communicated to the client device as text, an image (e.g., a company logo), a sound file, video file, or a combination thereof. Further, product samples or physical stimuli can be delivered prior to the respondent participating in the research. One or more screening questions may be asked (act 204) to determine whether the participant should be included in the particular study being pursued. For example, the participant may be asked whether he or she has ever heard of the topic of inquiry. The screening question responses may be received and analyzed (act 206), and if it is determined that the participant should continue with the session, a plurality of images is sent to the client device, and the participant is asked to select a number of images (act 208).

The participant may be asked to select images which represent the participant's thoughts and feelings about the topic of inquiry in some embodiments. Other suitable requests regarding the selection of images may be sent to the participant instead of, or in addition, to this request. For example, a participant may be requested to select images which relate to the topic of inquiry, or asked to select images which do not represent his or her thoughts and feelings about the topic of inquiry.

In some embodiments, the participant may be asked to select a particular number of images, while in other embodiments, a particular number may not be specified as part of the request. For example, the participant may be requested to select “several images” or “as many images as you wish”. In some embodiments, the server device may send a request to the client device asking the participant to select a single image or to select a number range of images.

Once the participant selects the image(s), one or more requests for the participant's comments regarding the images are sent to the client device. For example, the participant may be asked to describe each of the selected images (act 210). Other examples include inquiring as to the participant's reason(s) for selecting each image, or asking how the image relates to the participant's thoughts and feelings about the topic of inquiry (act 212). This act may include a dynamic interaction wherein certain responses or keywords initiate further questions to the participant. The participant may be prompted for comments about the images after all the images have been selected, or comments may be requested for each image immediately after an image is selected.

In an act 214, the responses are received from the participant via the client device. If the responses are received in an electronic text format, or converted into electronic text format, the responses may be searched and/or analyzed in a fully automated or semi-automated manner. Regarding responses from participants, for purposes herein, the terms “text”, “textual data”, “textual account”, and “text format” are intended to include responses from participants where the participants write responses, type responses, or input responses in an electronic format in a non-verbal manner, or any other suitable non-verbal manner of providing responses to requests. For purposes herein, the term “electronic text data” is intended to include data that represents text, regardless of whether the original comments or other data were input as text or instead input verbally and later transcribed to electronic text data.

The acts performed as part of method 200 or any other method according to embodiments disclosed herein may be ordered in any suitable way. Accordingly, embodiments may be constructed in which acts are performed in an order different than illustrated, which may include performing some acts simultaneously, even though shown as sequential acts in illustrative embodiments.

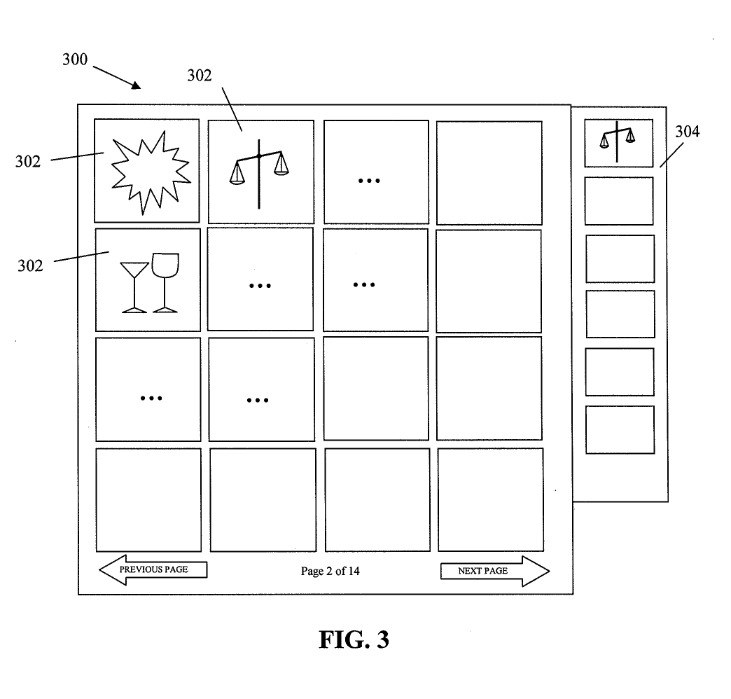

Certain embodiments of the acts discussed above will now be explained in more detail, though alternative embodiments may be used. As shown in FIG. 3, a plurality of images 302 may be presented to the participant on a computer monitor or other suitable display device as part of a user interface 300. The images may be divided into several pages or tabs of images in some embodiments, with each page displaying one or more images. For example, in the embodiment shown in FIG. 3, sixteen images are presented on one page in a four-by-four grid. In other embodiments, images may be displayed in a five-by-five grid, or in any other suitable arrangement. When the participant hovers a cursor over a particular image or touches an image using a touch screen interface, the image may be enlarged for better viewing. Each time a participant selects an image, a thumbnail version of the image may be added to a list of selected images 304 so the participant can keep track of the images and the number of images that he or she has selected.

The nature of the images from which the participant selects can be important to the quality of the results. For example, in some embodiments, the presented images are not obviously symbolic or iconic, as with the universal “peace sign”. The images do not stand in singularity, such as an image of the Statue of Liberty, for example. Taken as a whole, the images are intended to be culturally neutral in some embodiments so as to allow participants of various cultural backgrounds to find appropriate representations of their thoughts and feelings. Of course, any suitable images may be used in various embodiments described herein, including images that do not meet some or any of the criteria discussed above.

A database of images may be stored within the server device, or the database may be stored elsewhere. Approximately 500 images may be stored in some embodiments, though fewer than 500 images may be sent to each participant for a given study. The images received by participants may vary from participant to participant within a study. For example, a subset of images from a database of 500 images may be sent to a first participant in a study, and a different subset of images from the same database may be sent to a second participant in the same study. The order in which the images are presented to a participant may differ from participant to participant as well. For example, in some embodiments, images may be presented in a randomized order to each participant. In other embodiments, a certain number of particular sequential orders of images may be pre-selected, and different participants receive different sequential orders of images.

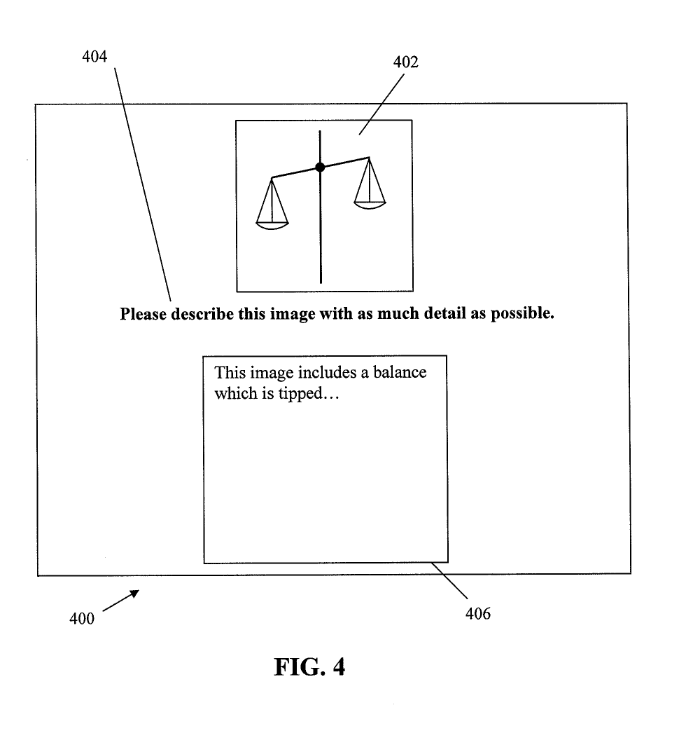

Once a participant has completed the selection of images, one or more requests for information may be sent to the participant. For example, in a user interface 400 shown in FIG. 4, the participant may be requested to describe each selected image 402 with a request 404. The purpose of this request is to understand what the participant believes to exist within the image. In some embodiments, the participant is asked to describe the image with as much detail as possible. The participant enters their response in a text window 406 by typing a response or entering a text response in another suitable manner. In some embodiments, the participant may speak the response and sound recording may be made, or speech recognition software may be used to produce electronic text data.

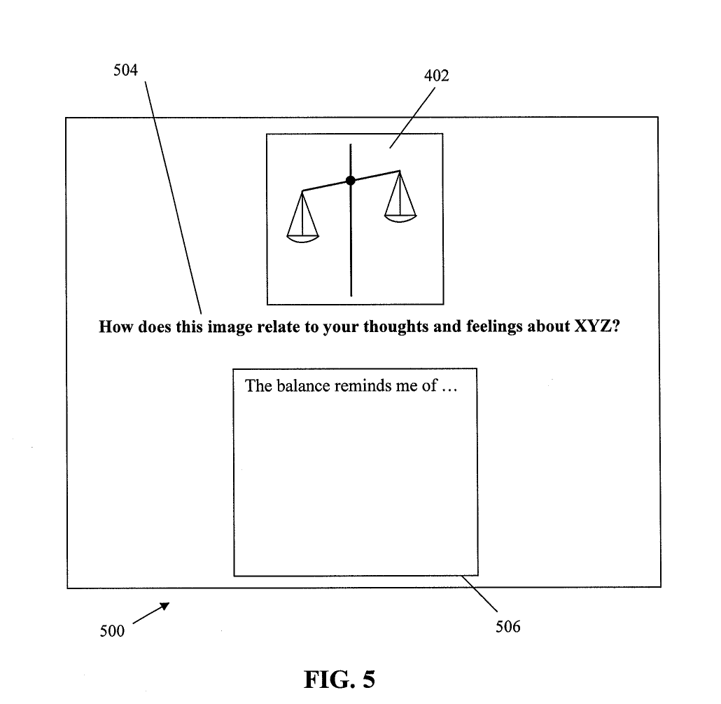

A second request may ask the participant to explain how the participant associates the image with the topic of inquiry. For example, as shown in FIG. 5, the participant may be asked in a request 504 to explain how the image relates to his or her thoughts and feelings about the topic. The participant may enter his or her response in a text window 506. In another example, a query may be sent requesting the participant to describe why the image represents his or her opinion of the topic. This second request may be presented after the participant has described the selected image 402, or, in some cases, the second request may be presented before the image description request.

While two specific requests are shown and described with relation to this embodiments, additional requests may be included, or different requests may be presented in place of one or both of requests 404, 504. In some embodiments, different requests are sent to different participants, and requests may be dependent on which image is selected.

In some embodiments, moderation sessions or one-on-one interviews may be initiated to follow up and elaborate on responses received from one or more participants. The moderation and interview sessions may be used for all of the participants, or for a randomized subset of the participants, or for a subset of the participants based on various criteria. For example, moderation sessions may be initiated by the server device in response to pre-selected keywords. In some embodiments, a person may actively monitor received responses, and after an initial analysis of responses, a moderation session may be launched.

In some embodiments, a small number of participants may be invited to take part in the survey portion of a study as part of an initial test group to confirm that the survey is performing as intended. Once the initial survey has been evaluated, and possible revisions to the survey have been made, the survey portion may be sent to the full number of participants, or a larger subset than the original test group.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one or more of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, embodiments of the invention may be embodied as a computer-readable storage medium or multiple computer-readable media encoded with one or more programs that, when executed on one or more computers or other processors, perform methods that implement the various embodiments of the invention discussed above. Computer readable media may include, for example, a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the embodiments of the invention may be embodied as a computer-readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of embodiments of the present invention need not reside on a single computer or processor, but may be distributed in a modular fashion amongst a number of different computers or processors to implement various aspects of embodiments of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

It should also be understood that, unless clearly indicated to the contrary, in any methods claimed herein that include more than one step or act, the order of the steps or acts of the method is not necessarily limited to the order in which the steps or acts of the method are recited.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

What is claimed:

1. A server device configured to elicit descriptions from participants regarding relationships of images to a topic of inquiry, the images being obtained from a computer storage medium storing a group of images, the server device comprising one or more processors configured by stored program instructions to:
send an indication of a topic of inquiry to a plurality of client devices which are remote from the server device;
send a plurality of images from the group of images to each of the client devices;
send a first request to each of the client devices for display to an associated participant, the request requesting the participant to select a number of images, from among the plurality of images, which the participant associates with the topic of inquiry;
send a second request to each of the client devices for display to the associated participant, the request requesting the participant to explain how the participant associates the selected images to the topic of inquiry;
receive the explanations of how the participants associate the selected images to the topic of inquiry; and
store on a computer storage medium identifications of the images selected by participants and the explanations associated with the selected images.

2. The server device of claim 1, wherein the first request requests the participant to select a number of images from among the plurality of images which the participant regards as representing his or her thoughts and/or feelings about the topic of inquiry.

3. The server device of claim 2, wherein the second request requests the participant to explain how the selected images relate to his or her thoughts and/or feelings about the topic of inquiry.

4. The server device of claim 1, wherein the first request is sent to various client devices of the plurality of client devices at different times.

5. The server device of claim 4, wherein the first request is sent to various client devices of the plurality of client devices at times selected by the participants.

6. The server device of claim 1, wherein the plurality of client devices comprises at least 50 client devices.

7. The server device of claim 1, wherein the plurality of client devices comprises at least 200 client devices.

8. The server device of claim 1, wherein the plurality of images comprises a plurality of photographic images.

9. The server device of claim 1, wherein the plurality of images comprises images which are not related to the topic of inquiry in a literal manner.

10. The server device of claim 1, wherein the first request and the second request are sent over a computer network.

11. The server device of claim 1, wherein the one or more processors are configured by stored program instructions to receive the explanations of how the participants associate the selected images to the topic of inquiry at different times for different participants.

12. The server device of claim 1, wherein the second request requests the participant to textually input their response.

13. A computer-implemented method of eliciting written accounts from participants regarding relationships of selected images to a topic of inquiry, the method comprising acts of:
(a) sending an indication of a topic of inquiry to each of a plurality of participants;
(b) operating a computer-implemented system to send a plurality of images to each participant;
(c) sending a request to each participant to select a number of images from among the plurality of images which the each participant associates with the topic of inquiry; and
(d) sending a request to each participant to provide a textual account regarding how the participant associates images selected by the participant with the topic of inquiry.

14. The computer-implemented method of claim 13, wherein act (c) comprises sending a request to each participant to select a number of images which the each participant regards as representing his or her thoughts and/or feelings about the topic of inquiry.

15. The computer-implemented method of claim 14, wherein act (d) comprises sending a request to each participant to provide a textual account regarding how the images selected by the participant relate to his or her thoughts and/or feelings about the topic of inquiry.

16. The computer-implemented method of claim 13, wherein act (b) comprises sending the images to various participants from among the plurality of participants at different times.

17. The computer-implemented method of claim 16, wherein act (b) comprises operating a computer-implemented system to send the images to various participants from among the plurality of participants at times selected by the participants.

18. The computer-implemented method of claim 13, wherein the plurality of participants comprises at least 200 participants.

19. The computer-implemented method of claim 13, wherein act (b) comprises sending a different plurality of images to each participant.

20. The computer-implemented method of claim 13, wherein act (b) comprises sending the same plurality of images to each participant.

21. The computer-implemented method of claim 13, wherein the images comprise photographic images.
